(19) United States
(12) Patent Application Publication
(10) Pub. No.: US 2023/0300236 A1
(43) Pub. Date: Sep. 21, 2023

(54) Detection of emergency events through Computer Vision and edge devices

(71) Applicant: Jessica Denise Respus, Fayetteville, NC (US)

(72) Inventor: Jessica Denise Respus, Fayetteville, NC (US)

(21) Appl. No.: 17/695,875

(22) Filed: Mar. 16, 2022

(51) Int. Cl. H04M 1/72424; G08B 7/06; G08B 17/10

(52) U.S. Cl. CPC H04M 1/72424; G08B 7/062; G08B 17/10

(57) ABSTRACT

The present invention discloses an advance fire and shooting emergency response system where the apparatus allows families and children to get themselves educated, plan and at promptly and intelligently at the time of fire and other emergency situations. The application is based on artificially intelligent algorithms and transmits the user information and location to the respondent server and can also send messages to already enlisted neighbors, family and friends to immediately alert them about emergency and location. The system is also able to send various types of reminders including but not limited to evacuation plans, monthly fire drills, monthly smoke detector check notifications, window check notifications and daily safety facts. It also provides single push button which once pushed by the user can send signals to immediate circle of user and first line responders teams and also allows the option to send message to explain the type of danger child is in. The assembly is easy to install, safe to use and is suitable for all ages.

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND

### Field of the Invention

This invention relates to security domain and, more particularly, to an emergency response system that keep children alert and safe by creating checklists, performing practice drills, evacuation meetings and tracking all relevant data.

### Description of the Related Art

For one week every year, “Fire Safety Week”, virtually every school student is exposed to fire safety information. Unfortunately, it is usually only “exposure”, with very little instruction or experience to which the typical child can relate. The children draw posters, enter contests, and sometimes visit fire stations, but few children associate the information they receive with their own lives.

The danger to children from home fires is very real, and the difference between survival and death is often the difference between teaching a child what to do when there is a fire and doing nothing. Yet, there has been no facility available to teach children, particularly young children who learn best by experience rather than lecture, what to do when fire breaks out.

According to the U.S. Fire Administration, in 2019, children aged 0-14 faced a rate of 4.0 deaths per million due to house fires. Ninety percent of all fire-related deaths are due to home fires. In the United States, nearly 488 children (ages 14 and under) die in home fires, and another 116,600 children are injured from a fire/burn related incident each year. Every day, at least one child dies from a home fire and another 293 children are injured from fires or burns. House fires can be caused by a number of external circumstances including electrical malfunctions, faulty wiring, candles, cooking equipment and more. No child should ever have to perish in a fire. With the right tools and education, children can reduce their chances of being injured and learn what to do if an emergency strikes. Dean and school owner Dr. Jessica Respus founded LDA with all children in mind, to provide systems, tools and services for parents to ensure their family is prepared in case they are ever faced with a fire. The program covers everything from digital alarms to fire drill templates, evacuation plans and more. Dr. Respus plans to take the program nationwide and inside every household for the safety and wellbeing of children.

Child safety is crucial in a number of different circumstances. At school, children participate in fire drills and buildings are regularly inspected by a fire marshal. Thousands of children can effectively evacuate a huge school building in a matter of minutes with the right system and training in place. They even partake in National Fire Prevention Month, in which children learn about fire safety.

Unfortunately, many of these safety measures do not continue at home. Parents teach their children how to avoid and escape from strangers, what to do if they are approached by an unfamiliar person or how to handle a break-in. However, they are often not taught what to do at home in case of a fire. This lack of an instructional facility is most probably do to cost as much as anything else, because it is clearly very costly to build or dedicate a building for teaching children fire safety by simulating the problems of fire in the home. Similarly, a consistent fire response system making them habitual of response in fire situation is also required.

By looking at prior art there are many inventions that have been registered in prior art regarding emergency response system, however their utility in above mentioned requirement is minimal. For instance, a Danger warning and emergency response system and method bearing U.S. patent U.S. Pat. No. 6,084,510A is issued to Lemelson; Jerome H., Pedersen; Robert D. The patent discloses a surveillance platforms in airborne craft (8,10), land based vehicles (12), vessels at sea or fixed structures (14) detect dangers using conventional scanners and transmit information signals describing the dangers to a control center (2) which analyzes the data and determines the degree of danger and its geographic extent. The center generates a danger warning and emergency response including a danger index. The warning/response message identifies the degree of danger (danger index 144) and the GPS coordinates (142) of the impacted geographic area for a wide region or regions of the earth (FIGS. 2-6). A vulnerability index (FIG. 16) determined using neural networks (FIGS. 13-14) and fuzzy logic (FIGS. 15-20) enables a prioritized warning/response. The center broadcasts (18) the danger warning and emergency response (FIG. 9) to a large population of remotely located warning devices (11), such as a network of pagers each of which has a GPS receiver (6,28). The pagers compare the received danger coordinates with their own GPS coordinates and each pager determines the extent to which it is in danger. The warning device automatically issues a warning signal or signals, which may be audible, visual or vibratory, appropriate to the degree of danger. Emergency manned vehicles may also directly receive the broadcast warning/response and be immediately alerted to act appropriately relative to the degree of danger. One embodiment broadcasts (16) directly to home T.V.'s and radios (17) which have internal GPS receivers and which display/annunciate an emergency message customized to that receiver resulting from the internal comparison of the danger coordinates versus the local receiver coordinates.

An emergency response system is issued to Hoskinson John D, Horton Stephen W. The patent discloses a 911 emergency response system that includes a location identification module, preferably in solid state circuit form, associated with each residence or each extension of a PBX is disclosed. Preferably, the location identification modules are powered by telephone line voltage. A location identification module is enabled when its associated telephone goes off-hook and an emergency code, e.g., 911 is dialed. Thereafter, in response to an inquiry from the emergency response center that receives the emergency call, the location identification module sends the location of the associated telephone to the emergency response center operator where the location is displayed on a dispatcher's console.

Telephone emergency response system and method is a U.S. Pat. No. 6,968,044B2 issued to AT&T Delaware Intellectual Property Inc. The patent discloses an emergency system and method includes a gateway; a switch in communication with the gateway and a controller; and a database in communication with the gateway. The database includes first routing information for establishing a first communication link; second routing information for establishing a second communication link; and location data associated with the communication device. The method includes retrieving the first routing information; retrieving the second routing information; retrieving location data associated with the communication device; and establishing at substantially the same time, a first communication link between the communication device and the controller and a second communication link between the gateway and the controller such that information that is transmitted via the first and second communication links arrives at the controller at substantially the same time.

A Personal emergency response communications system is a U.S. Pat. No. 5,305,370A is issued to Lloyd Kearns, Petersen David E. The patent discusses a personal emergency response system in which a hand held portable transmitter (12) activates a base unit (14) interfaced with the telephone network (16) to dial 9-1-1 and permit direct communications with the operator (18) at the public safety answering point even though the user (10) is unable to reach a telephone (36). The transmitter (12) activates the base unit (14) as well as optional remote units (48) located throughout the user's residence or place of business. The base unit (14) and remote units (48) include speaker-phone communication capabilities which permit two-way communications between the user (10) and the 9-1-1 system operator (18).

Emergency response personnel automated accountability system is a U.S. Pat. No. 7,091,852B2 is issued to Tri Sentinel Inc. The patent discloses an emergency response personnel automated accountability system, also referred to as a Firefighter Automated Accountability System (FAAS), is provided that supports automatic tracking of and limited communications among first responders including fire, police, emergency medical service, and safety personnel. The FAAS increases situational awareness and safety of first responder personnel by automatically providing position information as well as other sensor information. Components of the FAAS integrate wireless mesh networks with positioning and communication systems to support real-time tracking of and communications with emergency response personnel. The FAAS incident awareness system provides position and time information via Global Positioning System (GPS) and/or other positioning systems, and processed data from sensors to provide enhanced communications, command and control capabilities to the first responders and incident command at the incident scene.

A U.S. Pat. No. 7,395,151B2 is a System and method for knowledge-based emergency response is issued to O'neill Dennis M, Guillermo Francisco Arango. The system discloses a knowledge-based system and method for establishing and managing routes for emergency vehicles. The knowledge-based system and method uses a knowledge base having information useful in establishing and managing routes for emergency vehicles including information on intersections, road segments connecting intersections, expected travel time along the road segments, and dynamic factors that influence traffic flow, and a database for storing routes designed using the information useful in establishing and managing routes. The knowledge-based system also consist of one or more software modules operable to retrieve information from the knowledge base and to perform operations such as designing routes between location involved in emergency response, selecting between such routes, and modifying such routes all using information in the knowledge base.

A U.S. Pat. No. 2,005,026,7651A1 is a system and method for knowledge-based emergency response is issued to Guillermo Arango, O'neill Dennis M. The system discloses a knowledge-based system and method for establishing and managing routes for emergency vehicles. The knowledge-based system and method uses a knowledge base having information useful in establishing and managing routes for emergency vehicles including information on intersections, road segments connecting intersections, expected travel time along the road segments, and dynamic factors that influence traffic flow, and a database for storing routes designed using the information useful in establishing and managing routes. The knowledge-based system also consist of one or more software modules operable to retrieve information from the knowledge base and to perform operations such as designing routes between location involved in emergency response, selecting between such routes, and modifying such routes all using information in the knowledge base.

A U.S. Pat. No. 8,866,606B1 is a systems and methods for automated personal emergency responses is issued to Rockwilli RMR LLC. The patent discloses a subscriber device for use in an automated personal emergency response system implemented as a conference bridge on a remote computing network. The device, intended to be worn as a pendant, wristband or in another wearable configuration, includes a color high-resolution display for signaling a user of the subscriber device with notifications, arrows for directional guidance, and/or other status messages. The device also includes microphones and speakers for enabling a teleconference between a user of the subscriber device in need of assistance and parties joined to the teleconference via the automated personal emergency response system. The user of the subscriber device may initiate the call for assistance and teleconference via a press of a single button on the device; alternatively, accelerometers in the device may detect a fall and automatically initiate the call. The device can receive medical telemetry and provide it to conference participants and perform home automation tasks.

There are multiple solutions that have been presented in prior art. However, these solutions are limited and restricted to their conventional systems. It has to be noted that the current invention proposes an advancement in providing an advance Emergency response system in case of fire focused on children. The current invention as per its preferred embodiments provides parents with the tools to keep children safe, including but not limited to evacuation plans, monthly fire drills, monthly smoke detector check notifications, window check notifications, daily safety facts. This program aims to put an end to the hundreds of deaths children face each year as a result of home fires. Not only that, but the skills and information children learn in this program will serve them well for the rest of their lives.

Furthermore, School shootings-terrifying to students, educators, parents, and communities-always reignite polarizing debates about gun rights and school safety. There have been 104 school shootings since 2018, when Education Week began tracking such incidents. The highest number of shootings, 34, occurred last year. There were 10 shootings in 2020, and 24 each in 2019 and 2018. School shootings, such as those at Columbine and Sandy Hook, plague the national consciousness and highlight deficiencies in preparedness and response to such tragedies. Existing technology, developed for military applications and environments, is not suited for application in schools, nor are they affordable to civilians. By looking at prior art multiple types of emergency response systems are developed for first responders' team. However, the utility of these system for general masses especially children is very weak. U.S. Pat. No. 7,411,865, discloses a system and method for archiving and retrieving gunshot detection and location information from an array of remote sensors and preserving audio information surrounding a gunshot event for later review or analysis.

U.S. Pat. No. 7,688,679, discloses a system for locating and identifying an acoustic event, such as gunfire, employing a plurality of wearable acoustic sensors, with each acoustic sensor having a display associated therewith for displaying information concerning the acoustic event to a user. The sensor includes a microphone for receiving acoustic information, an A/D converter, a processor for processing the digitized signal to detect a gunshot and determine a time of arrival, a GPS receiver for determining the position of the acoustic sensor, and a network interface for bidirectional communication with a system server.

U.S. Pat. No. 7,961,550, discloses a systems and method for processing signals, particularly gunshot acoustic signals, the method including transforming initial bullet data associated with one or more sensors into a set of discrete pulses, dividing the discrete pulses into pulse subsets, generating, for the subsets, time domain representations of the pulses, wherein the time domain representations include waveforms having pulse features, and processing the time domain representations to determine alignment between one or more of pulse features, pulses, pairs of channels, and/or pairs of sensors.

U.S. Pat. No. 8,351,297, discloses systems and methods for processing information associated with monitoring persons/devices and weapon fire location information. A weapon fire location system is used to characterize and locate impulsive events and these locations are correlated with the positions of monitoring persons or devices, such as monitoring anklets placed on offenders.

U.S. Pat. No. 8,325,563, incorporated herein by reference in its entirety, discloses a system and method for locating a source of an acoustic transient, such as a gunshot, explosion, weapons launch, etc. The method is said to permit locating of the acoustic transient from a combination of propagation phenomena including a discharge time of the weapon fire incident.

There are multiple inventions that are developed in case of shooting emergency however their utility for children is questionable. The current invention aims to provide a novel approach where with the click of a button through the LDA app, the caregivers and first responders will be notified that child is in trouble. This LDA app is also coupled with a secure tracking feature to help emergency personnel quickly locate the child in an event of emergency.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The primary desirable object of the present invention is to provide a novel and improved form of emergency response system in case of fire focused on children safety in multiple ways.

It is also the primary objective of the invention to provide an evacuation plans which allows families to create a structured plan to evacuate their home in case of a fire

It is also the objective of system to provide family meeting point feature to ensures children have the advanced knowledge of where to meet their family in case of a housefire.

It is another objective of the invention to provide a smart Monthly Fire Drills allowing families to schedule fire drills monthly.

It is also the objective of the invention to provide Smoke Detector Reminder to reminds children and families to test smoke alarm/detector working condition on monthly basis.

It is the most important objective of the invention to provide a monthly reminder to ensure that home and facilities are protected by identifying two ways out of every room, and make sure that exits are not blocked unnecessarily in case of during an emergency.

It is also the objective of system to provide daily fire safety facts allowing to send daily notifications of fire safety facts to keep the user informed and aware of general fire safety.

It is also the objective of invention to provide a tracker which will help emergency management services locate the person quicker, and will be accomplished by accessing the tracking app of one of the member's phones that made it out of the home safely.

It is further the objective of the invention to provide an emergency response system that provides call to 911 by single push button in case of emergency event recognition. In-addition there is a danger notification button and with a simple push it can alert others of the emergency situation.

It is also the objective of the invention to provide in addition to the push button to let guardians know that their child is in trouble, but can also send a message letting the parent know the type of danger they're in.

It is also the objective of the invention to provide a smart assembly which provides enhanced reaction time in case of any emergency.

It is also the objective of the invention to provide services to track and locate the child quicker, by accessing the tracking app of the parents' phone.

A further object is to provide an assembly which is convenient and easy to use for children, adults or elderly.

Still yet another object of the present invention is to provide a new and improved fire emergency response system which provides in the apparatuses and methods of the prior art some of the advantages thereof, while simultaneously overcoming some of the disadvantages normally associated therewith.

Other aspects, advantages and novel features of the present invention will become apparent from the detailed description of the invention when considered in conjunction with the accompanying drawings.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 shows the process flow of proposed invention.

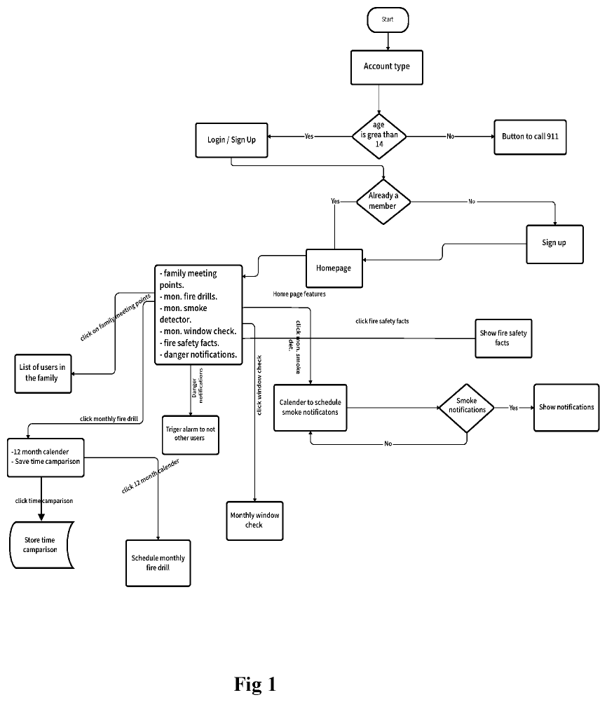

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The present invention is directed to an advanced emergency response system in case of fire allowing families and especially children to learn the protocols, prepare themselves and home facility and perform quick and safe actions during house fire.

The assembly as per illustrative embodiment is a system where it discloses a new process of dealing with emergency situations through a smart methodology. The proposed invention can be use by all people and specially children to get help and support and evacuate in a very short time.

The proposed invention works in form of an application which can be downloaded easily at user's smart devices. The invention is based on components of an exemplary environment in which the invention may be used. The proposed system has focused components and is based on simple to use. The system can be used in online and offline mode, thus allowing the accessibility to its users in every type of circumstances.

The invention, which is a fire safety system can be viewed and used from a personal computer, laptop, PDA or any computing device. In order to use the application, the user has to be connected to internet to provide and receive the feedback in real time. For real time utility needs to be connected to internet through local area networks (“LANs”)/wide area networks (“WANs”), wireless network or independent internet source. Further, the internet would connect the user to the online feedback application server, through the user's computing or mobile device, where applicable.

Generally, client device may include virtually any computing device capable of receiving and sending a message over a network, such as LAN/WAN or independent network, wireless network, and the like, to and from another computing device, such as server or mobile device, and the like. The set of such devices may include devices that typically connect using a wired communications medium such as personal computers, multiprocessor systems, microprocessor-based or programmable consumer electronics, network PCs, and the like. The set of such devices may also include devices that typically connect using a wireless communications medium such as cell phones, smart phones, Tablets or PDAs. Similarly, client device may be any device that is capable of connecting using a wired or wireless communication medium such as a PDA, POCKET PC, wearable computer, and any other device that is equipped to communicate over a wired and/or wireless communication medium.

Client device may include a browser application that is configured to receive and to send web pages, web-based messages, and the like. The browser application may be configured to receive and display graphics, text, multimedia, and the like, employing virtually any web-based language, including Standard Generalized Markup Language (SMGL), HyperText Markup Language (HTML), and so forth.

Client device may also include mobile computing devices especially the smartphone, which allow the user to download the application and use it on one click. The online website has a responsiveness mode for the application to function in full on the mobile computing device. Any mobile computing device can be used by the user for using the application. Such devices include portable devices such as, cellular telephones, smart phones, Personal Digital Assistants (PDAs), handheld computers, wearable computers, tablet computers, integrated devices combining one or more of the preceding devices, and the like. The application can be downloaded easily free of cost from Google Play store. The application will also be available on iOS system by Apple in future.

In an embodiment, the system is designed to have two ends. One is the front end which is designed as the front panel with GUI for taking the user's input and the second one is the back end that is the server end. All information entered is stored in the database server according to given format. The same database gives and shares the reminders with user. The user registration is also stored and verified by the same server. The server is also been used to host the site and application.

The application is backed by Artificial Intelligence (AI). Upon the detection of any such incident, an emergency message will be generated, and respective authorities/individuals will be alerted. These emergency or alert messages can either be sent through call, messages, email or a specific mobile app notification on which it will notify the concerned authorities and individuals regarding the incident and its location.

The system as per its further embodiments provides evacuation plan feature allowing families to create a structured plan to evacuate their home in case of a fire. This includes the ability to structure an evacuation plan that is suitable for all household members. For example, you will need to wake babies and very young children and help them get out. The plan specifies who will help each child get out safely.

The system as per its further embodiments provides family meeting point feature to ensures children have the advanced knowledge of where to meet their family in case of a housefire. Children should know what to do when they hear a smoke alarm and there is no adult around. The proposed invention helps them practice going to the outside meeting place, and teach them to never go back inside a building that is on fire.

The system as per its further embodiments provides Monthly Fire Drills allowing families to schedule fire drills monthly, which will help prepare their family for steps and procedures to take in case of a fire.

The system as per its further embodiments provides Monthly Smoke Detector Reminder which reminds children and families to test smoke alarm/detector monthly by pressing the button on the alarm that allows to test the unit, and to also change batteries if due.

The system as per its additional embodiments provides tracking feature in case of house fire or emergency situation once push button is triggered by the child. It will help the guardians or first responder teams to locate the child easily.

The system as per its further embodiments provides Monthly Window Reminder which ensure that home and facilities are protected. Users can identify two ways out of every room, and make sure that exits are not blocked unnecessarily in case of during an emergency.

The system as per its further embodiments provides daily notifications of fire safety facts to keep the user informed and aware of general fire safety.

In today's society there has arisen a need to provide protection for students against active shooters (gunmen) attacking defenseless victims on school campuses. There are many approaches being considered for such protection including but not limited to; more campus police, arming teachers, ballistic backpacks, etc. The present invention simply attempts to provide a button and by a simple click of button, the child's immediate circle and first line emergency response teams are notified. This innovative approach reduces the response timeline and can be very helpful in saving precious lives in case of emergency.

The system as per its further embodiments also aims to provide additional feature where a child along with informing the guardians or first responder team of emergency situation can send a message letting the parent know the type of danger, they're in. It also provides location feature to access the child easily in case of emergency.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1: An application developed on the idea of fire training and emergency response system utilizing the advanced technologies, enabling users and especially children to respond to emergency situations effectively where:
an online system with multiple fire safety features as per claim 1, which is available through a web portal and any mobile computing device, accessible through an app;
which can be downloaded and used at users' discretion;
an online system with multiple fire safety features as per claim 1, is user friendly and is accessible through any form of computing device by connecting to internet;
an online system with multiple fire safety features as per claim 1, the application is a web-based software application which is hosted through a server and has its own database for storing and sending reminders to users; and,
an online system with multiple fire safety features as per claim 1, which is designed to protect the privacy through encryption and other software tools.
